(19) United States
(12) Patent Application Publication
(10) Pub. No.: US 2020/0140258 A1
(43) Pub. Date: May 7, 2020

(54) RIDING CROP APPARATUS FOR STRIKING A HORSE

(71) Applicant: Ramon Domniguez, Saratoga Springs, NY (US)

(72) Inventor: Ramon Domniguez, Saratoga Springs, NY (US)

(21) Appl. No.: 16/450,995

(22) Filed: Jun. 24, 2019

Related U.S. Application Data
(63) Continuation-in-part of application No. PCT/US19/59502, filed on Nov. 1, 2019.

(51) Int. Cl. B68B 11/00

(52) U.S. Cl. CPC B68B 11/00

(57) ABSTRACT

A riding crop for striking a horse having a shaft formed of a rigid interior pole having a resilient exterior cover and a unitary popper is defined by an elongated body. The riding crop additionally includes a handle covering or positioned adjacent to the proximal end of the shaft. The popper is positioned over or adjacent to the distal end of the shaft, with the shaft extending between the handle and the popper. The handle provides a surface that allows a user to hold the riding crop and the popper is the portion of the riding crop intended to contact a horse. The popper is defined by an oblong, bulbous member which is formed as a unitary one-piece structure and which includes an aperture that extends longitudinally through the popper from the end which forms the distal end to the shaft.

### CROSS REFERENCE TO RELATED APPLICATIONS

This application is a continuation in part of, claims the benefit of, and incorporates by reference co-pending PCT patent application serial number PCT/US18/59502 filed Nov. 6, 2018.

### BACKGROUND OF THE INVENTION

### Field of the Invention

This invention relates generally to equestrian equipment and, more particularly, to a riding crop having a shock absorbing shaft and a popper defined by a hollow, unitary structure.

### Description of the Prior Art

The use of conventional riding crops to control and encourage a horse to act, run or gallop in a certain manner such as during a horse race or other equestrian event is well established. Such conventional riding crops may feature a long, semi-flexible shaft having a handle intended to be grasped by a user at one end and a popper intended to make contact with a horse at the other end. In this regard, a rider disposed on the back of a horse can utilize a riding crop by flicking their wrist while holding the handle to cause the riding crop to accelerate rapidly and the popper to contact the horse's rump, side or hindquarters.

Because the popper is intended to contact the horse when a riding crop is employed, the popper is typically designed to reduce or minimize the amount of pain and injury inflicted upon the horse. One type of conventional popper design comprises a rectangular strap or loop of leather or similar material that is folded over on itself and extends axially from the end of the shaft of the riding crop that is opposite the handle. Such a folded-over strap provides a relatively wide, flat and highly flexible surface that distributes the striking force of the popper over a larger area and allows the popper to bend or flex against the horse on contact so as to reduce the impact felt by the horse and ideally reduce trauma and the chance of breaking skin. With such a popper design, however, the riding crop may unintentionally rotate or twist in the user's hand, causing the popper to not contact the horse squarely along the flat surface but rather along an edge of the folded-over portion. Moreover, even when used as intended, a flexible leather strap may still harm or injure the horse.

More recently, a design for a riding crop has been introduced in which the popper comprises a bulbous, oblong implement that is defined by a padded member operative to cushion or soften the striking force thereof that is contained within a water resistant outer sleeve (see, U.S. Pat. No. 9,260,287, issued to Dominguez, the disclosure of which is hereby incorporated by reference herein in its entirety). While such a sleeved pad popper design may have been superior to existing conventional designs, it created several disadvantages that could lead to reductions in efficacy and the useable life of the entire riding crop. For example, the use of an outer sleeve with a closed distal (relative to the handle) end introduces additional weight the end of the popper that could increase the striking force of the popper, particularly if the distal end of the popper contacted the horse first. In addition, if the padded member over time lost some of its resiliency and began to flatten, it would no longer fit snugly in the outer sleeve and the outer sleeve could begin to bunch on the surface of the popper. Such bunched material could create a substantially more inflexible surface that could contact the horse.

Moreover, in the event that the outer sleeve no longer fit snugly on the padded member, fluid material, such as air or water, could get trapped in between the padded member and the outer sleeve. This could cause the popper to generate multiple impacts on the horse when in use, including an impact when the sleeve hit the horse and another impact when the padded member in the sleeve hit the horse. It could also cause an increase in the weight of the popper, resulting in a greater impact on the horse being hit and changing the needed balance a rider has with the riding crop, compromising its handling.

Further, if the outer sleeve no longer fit snugly on the padded member, the outer sleeve may become prone to breaking due to the movement of the padded member therein (such as having the shaft and/or padded member breaking out of the outer sleeve)—which could also lead to liquid getting into the popper. And because the construction of the sleeved pad popper design was not one that enabled an end user to be able to reasonably repair or replace once it failed, any such failure scenario for the popper could result in the entire riding crop being no longer usable.

With respect to the shaft of existing riding crops, it is noted that even if such shafts are formed of materials that demonstrate some degree of flexibility or plasticity, they typically are formed of relatively rigid materials that have little ability to absorb energy when it is deformed elastically.

Thus, there remains a need for a riding crop apparatus for striking a horse having a shaft which includes a surface made of a resilient material and a unitary popper constructed to provide an advantageous weight distribution, reduce the risk of complete failure in the event of any deterioration of the popper, and to be able to be replaced by an end user in the even the popper deteriorates.

### SUMMARY OF THE INVENTION

The present disclosure describes an apparatus for striking a horse, such as a riding crop, comprising: a shaft formed of a rigid interior pole having a resilient exterior cover; a handle integral with the shaft; a popper defined by a unitary, single piece member that is integral with the shaft and has an exterior popper end which forms a first end of the popper, wherein the shaft, handle, and popper together form an elongated body that has a proximal end and a distal end; wherein the shaft includes at least a first portion having a first cross section that extends longitudinally between the handle and the popper, the handle extends longitudinally from the proximal end towards the distal end, and the popper extends longitudinally from the distal end towards the proximal end such that the exterior popper end forms the distal end of the elongated body; and wherein the popper has a second cross section that is greater than the first cross section and includes a hollow interior channel that has at least a narrow portion which is defined by an aperture that extends longitudinally into the exterior popper end.

Embodiments of the riding crop may include a tapering section at an end of the popper that is opposite the first end and that is defined by an angular narrowing between the second cross section and the first cross section.

### BRIEF DESCRIPTION OF THE DRAWINGS

FIG. 1 is a perspective view of an expanding handle embodiment of a riding crop apparatus for striking a horse built in accordance with the present invention.

FIG. 2 is a side elevational view of a cross section of an expanding handle embodiment of a riding crop apparatus for striking a horse built in accordance with the present invention.

FIG. 3 is an exploded side elevational view of an embodiment of a riding crop apparatus for striking a horse built in accordance with the present invention.

FIG. 4 is an elevational view of a cross section of the popper of an embodiment of a riding crop apparatus for striking a horse built in accordance with the present invention taken along line 4-4 of FIG. 3.

FIG. 5 is an elevational view of a cross section of the shaft of a riding crop apparatus for striking a horse built in accordance with the present invention.

FIG. 6 is an enlarged, partial side elevational view of the tapering section of the popper of a riding crop apparatus for striking a horse built in accordance with the present invention.

### DETAILED DESCRIPTION OF THE INVENTION

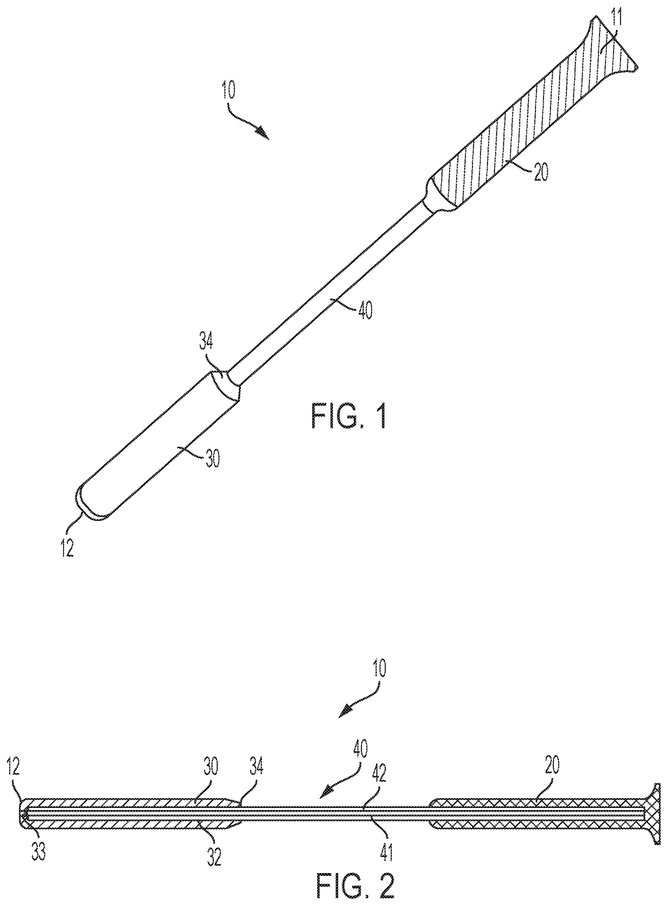

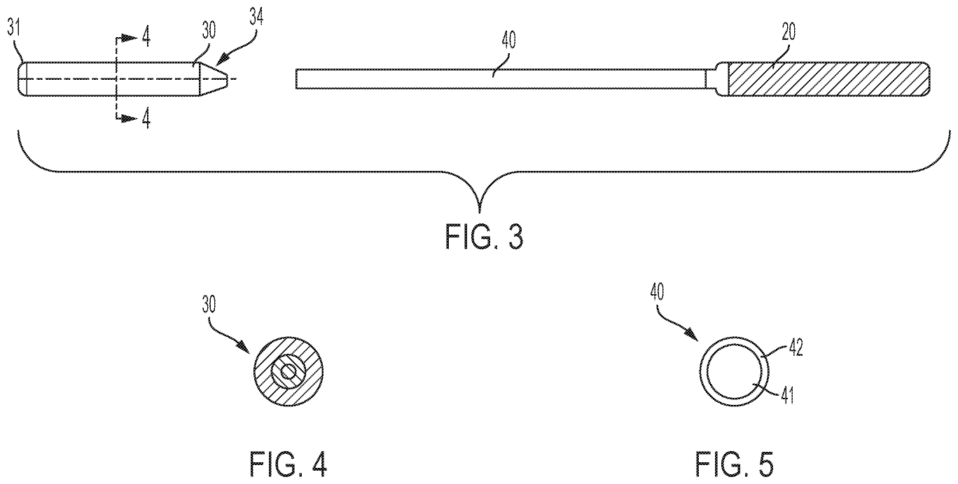

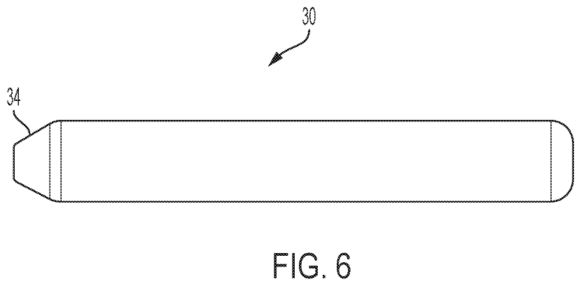

Described herein is a riding crop apparatus for striking a horse having a shaft with a resilient surface and a unitary popper whose single piece structure provides for an edgeless longitudinal striking area and an advantageous weight distribution, reduces the risk of complete failure in the event of any deterioration thereof, and is able to be easily replaced by an end user. Referring now to the drawings and in particular FIGS. 1, 2, 3, 4, 5, and 6, Applicant's riding crop is shown as a riding crop 10 of the type used by riders to control a horse by striking its flank or hindquarters. The riding crop 10 is defined by an elongated body that has a proximal end 11 and a distal end 12. The riding crop 10 includes a handle 20 positioned adjacent to the proximal end 11, a popper 30 positioned adjacent to the distal end 12, and a shaft 40 that extends between the handle 20 and the popper 30. The riding crop 10 may have any suitable length from the proximal end 11 to the distal end 12 such as, for example, about thirty (30) inches. It is contemplated that the overall length of the riding crop 10 will depend on the size of the horse, style of riding and other factors.

The shaft 40 may be defined by elongated, slender, generally straight rod. As illustrated in FIG. 2, in addition to extending between the handle 20 and the popper 30, the shaft 40 may also extend through the handle 20 all the way to the proximal end 11 and through most of the popper 30 almost to the distal end 12. In some configurations, however, the structure of the shaft 40 may terminate once it connects to the handle 20 at one end and/or the popper 30 at the other end.

The shaft 40 may be generally circular in cross-section. Alternatively, the shaft 40 may have non-circular cross-section shape, such as that of a polygon.

The shaft 40 is formed of a rigid interior pole 41 and a resilient exterior cover 42. The rigid interior pole 41 may be constructed of any suitable material such as fiberglass, carbon fiber, graphite composite or another similar material. The exterior cover 42 may be formed of a hollow tube having a two (2) millimeter circumferential wall and a six (6) millimeter interior space and constructed of latex or a synthetic type of rubber so as to provide a resilient surface for the shaft 40 that helps absorb the shock of impact of the riding crop 10 against the horse in the event the shaft contacts the horse. In embodiments wherein the shaft 40 extends into the popper 30, it is contemplated that the exterior cover 42 may also provide increased shock absorption when the popper 30 contacts the horse.

It is additionally contemplated that the interior pole 41 may be constructed of a material which provides some degree of flexibility or plasticity to help absorb the shock of impact of the riding crop 10 against the horse without breaking or snapping.

The exterior cover 42 may additionally include a silicone coating covering the exposed exterior or the shaft 40 to allow users to more easily slide the shaft 40 through their hands (which may be desirable when switching the riding crop 10 to their other hand).

The handle 20 extends across a portion of the riding crop 10 from the proximal end 11 towards the distal end 12 in order to provide a surface that allows a user to hold the riding crop 10. The handle 20 may be thicker or larger in diameter than the portion of the shaft 40 that extends between the handle 20 and the popper 30 for ease of handling. For improved gripping by the rider, the handle 20 may include a rubber coating that may be spirally striated along its length. In some configurations, however, a length of tape may be helically wrapped around a portion of the shaft 40 proximate to the proximal end 11 much like as is done with a tennis racket. The handle 20 may extend about twelve (12) inches or so along the shaft length from the far proximal end 11 so that riders can adjust their grip of the shaft at various locations.

The popper 30 extends across a portion of the riding crop 10 from the distal end 12 towards the proximal end 11 and is the portion of the riding crop 10 intended to contact a horse when the riding crop 10 is in use. In this regard, the popper 30 is positioned on the riding crop 10 on the opposite end as the handle 20 and has an exterior popper end 31 that forms the distal end 12. The popper 30 is defined by an oblong, bulbous member which is formed as a unitary one-piece structure and may be circular in cross-section. The popper 30 may have a length such that the popper 30 generally forms the six (6) to seven (7) inches of the riding crop 10.

To ensure that the popper 30 strikes the horse before the shaft 40, the popper 30 may be thicker or larger than the portion of the shaft 40 that extends between the handle 20 and the popper 30. In this regard, the popper 40 may protrude radially relative to the exterior circumference of the shaft 40 so that the popper contacts the horse first. As exemplified in FIG. 4, in protruding radially from the shaft 40, the popper 30 may be round or circular in cross-section so as to present a smooth, radial curve that contacts the horse eliminating the chances of striking the horse along an edge do matter how the riding crop 10 rotates within a rider's hand.

The popper 30 may include a tapering section 34 that is defined by an angular narrowing surface from the popper's 30 circumference to the shaft's 40 circumference at the end of the popper 30 that is opposite the exterior popper end 31. Advantageously, this tapering section 34 allows a user of the riding crop 10 to more easily slide the riding crop 10 along its length in their hand, while may be desirable when the user is changing which hand they are holding the riding crop with, than a design in which the section between the end of the popper 30 that is opposite the exterior popper end 31 is curved or orthogonal (orthogonal relative to the shaft surface).

The unitary, single piece popper 30 includes a hollow interior channel which passes entirely through the popper 30 longitudinally and which includes a wide portion 32 and a narrow portion 33. The size of the wide portion 32 that corresponds to the size of the shaft 40 so as to allow the shaft 40 to slide into the popper 30 and be frictionally and/or adhesively secured thereto. The narrow portion 33 is smaller than the wide portion 32 and thus is sized to prevent the shaft 40 from being able to slide through it. In this regard, the narrow portion 33, which is positioned at the distal end 12, is configured to prevent the shaft 40 from sliding all the way through the popper 30. The narrow portion 33 may be cylindrical or have a polygonal cross section.

It is contemplated that the when the riding crop 10 is assembled, the narrow portion 32 will remain unfilled and will thus simply define an aperture in the popper 30 at the distal end 12. By having an aperture in the popper 30 at the distal end 12, it is contemplated that the weight of the popper 30 will be more equally distributed across its entire surface, solving the problem in weight distribution created by a solid end, such as when creating an enclosure at the distal end with an otherwise hollow popper or with a single piece popper having a closed end. In addition, it is appreciated that the aperture in the popper 30 also allows the popper 30 to be easily slid onto the shaft 40 as it allows air in the wide portion 31 to escape out of the narrow portion 32 when the shaft 40 is slid into the wide portion 31. In this regard, if the popper 30 becomes damaged or worn, a user can simply cut off the worn popper 30, apply adhesive to the shaft 40 (if adhesive is used in addition to or in the alternative to friction to hold the popper 30 in place on the shaft 40), and slide a new popper 30 on to the shaft 40.

The popper 30 may be constructed out of molded portion of foam that is waterproof and chemical resistant to prevent migration of fluid into the popper 30. It is appreciated that the cushiony material of the popper 30 allows it to partially collapse upon impact with a surface thereby absorbing the impact force and later resiliently recover their original shape. Further, the foam construction ensures that the popper 30 is airy and lightweight thereby reducing the weight of the riding crop 10 and thus the momentum of the striking force applied to the horse.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. An apparatus for striking a horse, comprising:
a shaft formed of a rigid interior pole having a resilient exterior cover;
a handle integral with the shaft;
a popper defined by a unitary, single piece member that is integral with the shaft and has an exterior popper end, wherein the shaft, handle, and popper together form an elongated body that has a proximal end and a distal end;
wherein the shaft includes at least a first portion having a first cross section that extends longitudinally between the handle and the popper, the handle extends longitudinally from the proximal end towards the distal end, and the popper extends longitudinally from the distal end towards the proximal end such that the exterior popper end forms the distal end of the elongated body; and
wherein the popper has a second cross section that is greater than the first cross section and includes a hollow interior channel that has at least a narrow portion which is defined by an aperture that extends longitudinally into the exterior popper end.

2. The apparatus for striking a horse of claim 1, wherein the handle has a third cross section that is greater than the first cross section.

3. The apparatus for striking a horse of claim 2, wherein the shaft includes at least a second portion that extends to the proximal end and the handle is positioned over the second portion of the shaft.

4. The apparatus for striking a horse of claim 1, wherein the narrow portion is cylindrical.

5. The apparatus for striking a horse of claim 1, wherein the narrow portion extends through the popper from the exterior popper end to the shaft.

6. The apparatus for striking a horse of claim 5, wherein the narrow portion has a fourth cross section that is less than the first cross section.

7. The apparatus for striking a horse of claim 1, wherein the popper includes a hollow interior channel which passes entirely through the popper longitudinally and additionally includes a wide portion that is adjacent to the narrow portion and sized to have the shaft positioned therein.

8. The apparatus for striking a horse of claim 7, wherein the shaft includes at least a third portion that extends into and completely fills the wide portion and the popper is secured to the third portion of the shaft.

9. The apparatus for striking a horse of claim 8, wherein the popper is cylindrical and extends radially from the third portion of the shaft.

10. The apparatus for striking a horse of claim 1, wherein the popper includes a tapering section at an end of the popper that is opposite the exterior popper end and that is defined by an angular narrowing between the second cross section and the first cross section.

11. An apparatus for striking a horse, comprising:
a shaft formed of a rigid interior pole having a resilient exterior cover;
a handle integral with the shaft;
a popper defined by a unitary, single piece member that is integral with the shaft and has an exterior popper end, wherein the shaft, handle, and popper together form an elongated body that has a proximal end and a distal end;
wherein the shaft includes at least a first portion having a first cross section that extends longitudinally between the handle and the popper, the handle extends longitudinally from the proximal end towards the distal end, and the popper extends longitudinally from the distal end towards the proximal end such that the exterior popper end forms the distal end of the elongated body;
wherein the popper has a second cross section that is greater than the first cross section and includes a hollow interior channel which passes entirely through the popper longitudinally and which has a narrow portion which is defined by an aperture that extends longitudinally into the exterior popper end and a wide portion that is adjacent to the narrow portion and sized to have the shaft positioned therein; and
wherein the handle has a third cross section that is greater than the first cross section.

12. The apparatus for striking a horse of claim 11, wherein the shaft includes at least a second portion that extends to the proximal end and the handle is positioned over the second portion of the shaft.

13. The apparatus for striking a horse of claim 11, wherein the narrow portion is cylindrical.

14. The apparatus for striking a horse of claim 11, wherein the narrow portion extends through the popper from the exterior popper end to the shaft.

15. The apparatus for striking a horse of claim 14, wherein the narrow portion has a fourth cross section that is less than the first cross section.

16. The apparatus for striking a horse of claim 15, wherein the shaft includes at least a third portion that extends into and completely fills the wide portion and the popper is secured to the third portion of the shaft.

17. The apparatus for striking a horse of claim 11, wherein the popper is cylindrical and extends radially from the third portion of the shaft.

18. The apparatus for striking a horse of claim 11, wherein the popper includes a tapering section at an end of the popper that is opposite the exterior popper end and that is defined by an angular narrowing beginning at the second cross section going to the first cross section.

19. An apparatus for striking a horse, comprising:
a shaft formed of a rigid interior pole having a resilient exterior cover and having a proximal end and a distal end;
a handle integral with the shaft, extending from the proximal end towards the distal end;
wherein the shaft includes at least a first portion having a first cross section that extends longitudinally between the handle and the distal end; and
wherein the handle has a second cross section that is greater than the first cross section.

20. The apparatus for striking a horse of claim 19, additionally comprising:
a popper defined by a unitary, single piece member that is integral with the shaft, extending from the distal end towards the proximal end, where the popper has an exterior popper end that defines the distal end; and
wherein the popper has a third cross section that is greater than the first cross section and includes a hollow interior channel that has at least a narrow portion which is defined by an aperture that extends longitudinally into the exterior popper end.
